(19) United States
(12) Patent Application Publication
(10) Pub. No.: US 2007/0202230 A1
(43) Pub. Date: Aug. 30, 2007

(54) Breadmaking Processes And Products

(76) Inventors: Philippe Desbuquois, Linselles (FR); Norbert Grouet, Marcq En Baroeul (FR); Hubert Maitre, Marcq En Baroeul (FR); Jean-Jacques Muchembled, Marcq En Baroeul (FR)

Correspondence Address: BIRCH STEWART KOLASCH & BIRCH, PO BOX 747, FALLS CHURCH, VA, 22040-0747, US

(21) Appl. No.: 11/631,528

(22) PCT Filed: Jul. 5, 2005
(86) PCT No.: PCT/EP05/07258

§ 371 Date: Mar. 16, 2007

(30) Foreign Application Priority Data
Jul. 5, 2004 (EP) 04015795.0

(51) Int. Cl. A21D 10/00

(52) U.S. Cl. 426/549

(57) ABSTRACT

The invention relates to prebaked frozen dough piece which makes it possible to produce a totally baked bread product for at least 5 minutes and to corresponding methods, baked products and improving agents.

The present invention relates to an improved process for preparing baked bread products from frozen, pre-baked dough, to the frozen pre-baked dough so obtained, and to corresponding baked products and bread improvers.

In the present context, bread-making concerns all the steps used to produce a baked bakery product, such as bread, by baking in an oven a dough or a dough piece after its fermentation, containing by definition at least the following ingredients: cereal flour, water and active baker's yeast. The term “cereal flour” refers to flour derived from a cereal or from a combination of several cereals.

The preparation of a baker's dough ready to be oven baked is a process comprising several steps, including at least one mixing process and at least one fermenting step.

Generally, a baker works on a continuous basis, which may affect the freshness of the bread. When baked in the morning, the bread remains fresh until early afternoon, then its quality deteriorates with drying or softening of the crust and loss of crispness and flavour. Today, modern consumers want their bread fresh at any time of day, including in the evening or on leaving work.

To meet this consumer demand, bakers were compelled to conduct several baking operations per day at different time intervals. However, preparing a dough ready to be baked is a time-consuming, labour intensive task and, at room temperature, the dough can be kept for only a short time before being placed in the oven.

Several processes have been developed to overcome this problem.

For example a “pre-baked dough” technology is known. This technology is characterized by a pre-baking step of the fermented dough which coagulates the core of the dough and forms a soft film on the outside, the precursor of the crust. One characteristic of traditional pre-baked dough is that there is no browning of said soft film: any slight browning indicates crust initiation and hence that the pre-baking stage has been overstepped. This translates as subsequent defects: loss of production yield and flaking of the crust after final baking. The pre-baking step is therefore a particularly delicate step. Traditional “pre-baked dough” technology in most cases excludes large size pieces on account of difficulty of causing the core to coagulate without allowing crust initiation. It is therefore most often used for bread rolls, half-length baguettes or short baguettes. The pre-baked dough can be either stored 24 to 48 hours under conditions avoiding drying out (fresh pre-baked), or it can be frozen. It is also important to ensure that drying of the pre-baked doughs is limited before, during and after freezing. At the time of final baking, typically at the sales outlet, frozen pre-baked dough is taken directly from the freezer to the oven. Fresh bread is therefore available at any time of the day after 10 to 20 minutes of final baking, depending on the shape and weight of the pre-baked dough pieces. One major detrimental defect of usual frozen, pre-baked dough technology is the shrinkage of the pre-baked dough pieces on final baking, which reduces their volume by at least 10%.

Documents U.S. Pat. No. 4,788,067 and U.S. Pat. No. 4,861,601 describe processes belonging to this pre-baked dough technology requiring a final baking step of the pre-baked dough lasting 10 to 15 minutes.

It has also been attempted to freeze the bread or similar product when fully baked, then to thaw it just before sale by placing in the oven for a short time. This method has two major defects: first the crumb dehydrates and causes rings or white patches to appear, and secondly the crust flakes apart. This method of fully baked frozen bread does not therefore make it possible to obtain bakery products of good quality.

The present invention concerns an improved bread-making process which allows baked products of good quality to be available throughout the day after a short baking time. In particular, the present invention allows said products to be given a final oven baking of 5 minutes or less.

According to the inventive process, it is also possible to greatly reduce the shrinkage of the dough during final baking. The inventive process also avoids detrimental crust flaking.

Under the present invention, the term “oven” refers to ovens in which baking of the dough is conducted by heat transfer. This term “oven” does not therefore cover microwave ovens. The ovens are preferably bakers' ovens, in particular of rack type or static type, or of deck type, or in the form of a horizontal or a vertical modular tunnel, but it may also be any household oven able to reach the indicated temperatures within the oven enclosure. Bakers' ovens allow the baking of bread dough at temperatures between 150° C. and 260° C., optionally with the injection of steam into the oven.

The term “baked product” refers to a fully baked product, ready to be eaten. In the traditional frozen, pre-baked process and in the invention, the baked product is therefore the product after final baking, and therefore differs from the pre-baked dough piece in that the latter has only undergone a pre-baking operation.

The present invention concerns a process for producing a baked bread product. In this process, a formed, fermented, dough piece ready to bake, corresponding to said baked product, is subjected to pre-baking in an oven until its crumb has coagulated and a coloured crust has been formed. The pre-baked dough piece obtained is frozen for storage. The fully baked product is obtained by final baking of the pre-baked dough piece in an oven for a time of 5 minutes or less, preferably for a time of 3 minutes or less, and further preferably between 2 to 3 minutes at an oven temperature of between 200° C. and 260° C. Advantageously, the final baking is conducted at an oven temperature of 220° C. to 260° C., more advantageously between 230° C. and 250° C.

It is generally desirable that the final baking time should not be less than 2 minutes.

According to one embodiment, pre-baking is conducted at an oven temperature of 220° C. to 260° C., preferably between 230° C. to 250° C.

In the present context, the terms “coloured” and “colouring” concern the browning of the crust during oven baking, this browning distinguishing in particular between the crust and the crumb.

Usefully, freezing of the pre-baked dough piece is best conducted so that its core temperature rapidly reaches −12° C. or less. Freezing may for example be conducted at an enclosure temperature of approximately −30° C.

After freezing and before final baking, the frozen, pre-baked dough piece is preferably stored at a temperature of −15° C. to −25° C., more preferably at −18° C. to −22° C., and further preferably at −18° C.

The frozen, pre-baked dough piece can thus be stored for several weeks, even for up to 6 months, or even up to one or two years.

During the final baking, the frozen, pre-baked dough piece may be placed directly in the oven i.e. in the frozen state. It is also possible to subject the frozen, pre-baked dough piece to a partial or full thawing step before it is placed in the oven for final baking.

According to the inventive process, it is possible in particular to obtain a baked product whose crust does not flake, and whose volume is at least equal to 95% of the volume which would be obtained if the formed, fermented, ready-to-be-baked dough piece had been fully baked directly in a single baking step with no freezing step.

As indicated above, the dough piece is by definition prepared with at least cereal flour, water (optionally in milk form or other water-containing product) and active baker's yeast.

Preferably, other ingredients having an improving role are also added during the preparation of the dough piece.

For example the dough piece ingredients, in addition to cereal flour water and yeast, may advantageously contain one or more food stabilizers and/or edible plant fibres.

The food stabilizers are in particular cellulose derivatives such as carboxymethylcellulose, pectins, alginates and carrageenans, guar gum, carouba gum, xanthan gum, gelatin, modified starch, pre-gelatinized starch and pre-gelatinized flour. They are preferably chosen from among food stabilizers corresponding to cellulose derivatives, chemically or physically modified starch, gums and pre-gelatinized flours, and in particular one or more food stabilizers chosen from among carboxymethylcellulose, xanthan gum, pre-gelatinized wheat flour, pre-gelatinized maize (corn) flour.

Preferably, the dough piece ingredients contain pre-gelatinized starch or a source of pre-gelatinized starch such as a pre-gelatinized cereal flour, such as pre-gelatinized wheat flour in particular.

The dough piece ingredients may also contain:
one or more sugars taking part in Maillard-type reactions in a quantity which firstly exceeds the quantity of said sugar(s) which is fermented by the yeast before the pre-baking step (in case of sugar which can be fermented by the yeast present in the dough piece, since this condition is a priori met when the sugar present cannot be fermented) and secondly which is sufficient to impart a colour to the crust during the pre-baking step and/or
proteins taking part in Maillard-type mechanisms.

Maillard-type reactions are all reactions in which, under the action of heat, the sugars having a reducing function will yield coloured compounds with the nitrogen-containing compounds. The most reactive sugars are sugars with 5 or 6 carbon atoms, but sugars with 12 carbon atoms such as sucrose, lactose and maltose also take part in these reactions.

Amongst the ingredients containing one or more sugars taking part in Maillard-type mechanisms and able to be used within the context of the present invention, particular mention may be made of: milk derivatives such as whey powder, milk permeate and milk powder, glucose, sucrose and sorbitol.

Amongst the ingredients containing one or more proteins taking part in Maillard-type mechanisms and able to be used within the context of the present invention, particular mention may be made of: milk derivatives such as whey powder, milk powder and milk-derived caseinates, and gluten supplements.

Therefore the dough piece ingredients may usefully contain at least one ingredient containing a sugar and/or a protein taking part in Maillard-type reactions, this ingredient being chosen from the family of whey powder, lactose, glucose (=dextrose), galactose, sucrose, fructose and sorbitol.

According to one embodiment, the excess sugar taking part in Maillard-type reactions, such as glucose or xylose, is at least partly and even fully provided during the fermentation of the dough piece by at least one enzymatic preparation.

Among the enzymatic preparations able to provide a sugar taking part in Maillard-type mechanisms and able to be used within the context of the present invention, mention may be made of amylases, amyloglucosidases, malted wheat flour and bacterial hemicellulases. Therefore the dough piece ingredients may in particular include said enzymatic preparation containing at least one amyloglucosidase (=glucoamylase=glucan-1,4-alpha-glucosidase).

The dough piece ingredients may also contain at least one enzyme chosen from the family of hemicellulases releasing sugars with 5 carbon atoms (called C5 below) such as xylose, and exoamylases, preferably maltogenic i.e. amylases whose end product is essentially maltose, this enzyme or these enzymes preferably being combined with and/or forming part of the enzymatic preparation containing at least one amyloglucosidase.

According to one implemented embodiment, proteins taking part in Maillard-type mechanisms are at least partly provided during the fermentation of the dough piece by at least one enzymatic preparation, such as a preparation containing a protease.

The dough piece is advantageously prepared with ingredients containing all the following:
a food stabilizer; and
an ingredient containing a sugar or proteins taking part in Maillard-type reactions, preferably whey powder and/or glucose.

Also advantageously, the dough piece is prepared with ingredients containing both:
a food stabilizer; and
an enzyme source which, during fermentation of the dough, provides sugars taking part in Maillard-type reactions, the food stabilizer preferably being a pre-gelatinized bread-making cereal flour, more preferably a pre-gelatinized wheat flour; the enzyme source preferably being an amyloglucosidase source, and further preferably a source of amyloglucosidase and hemicellulase giving C5 sugars, and still further preferably a source of amyloglucosidase, hemicellulase giving C5 sugars and exoamylase.

The dough piece usefully contains at least one of the three following bread-making adjuvants:

1) an oxidising agent;

2) an emulsifier;

3) an enzymatic preparation chosen from the group of non-maltogenic alpha-amylases, endo-alpha-amylases, hemicellulases these preferably being endo-xylanases, lipases, phospholipases, or a combination of these enzymatic preparations;

the preferred oxidising agent being ascorbic acid; the preferred emulsifiers being E472e and E472f emulsifiers (diacetyl-tartaric esters of mono- and diglycerides of fatty acids). The dough piece preferably comprises at least two of said three bread-making adjuvants, and further preferably these three bread-making adjuvants.

The dough piece ingredients may also contain as exoamylase source for example beta-amylase, malted cereals preferably malted wheat or malted barley further preferably malted wheat. The terms malted cereal flour or cereal malt or enzymatic extract of malt are considered to be equivalent, covered by the term “malted cereals”. This rule also applies when the cereal is specified by its name (wheat, barley).

Before pre-baking, the dough piece usefully has a hydration level of at least 62% in Baker's Percentage, which corresponds to a hydration of at least two points higher, or 2% in Baker's Percentage, than the conventional hydration of a dough piece fabricated in accordance with a conventional process with one single baking using the same bread-making flour (if the increase is considered with respect to the hydration or water content of the dough, it is at least 2/60=3.3%).

Another aspect of the invention concerns the use of a bread improver containing one of these combinations of ingredients, and in particular an improver according to the invention such as described below, for the preparation of a dough piece using a process of the invention to produce a baked product such as described above and using a process of the invention to produce a frozen, pre-baked, dough piece such as described below.

The invention also concerns a process to prepare a frozen, pre-baked, dough piece able to yield a baked bread product by a final baking, corresponding to a stay time in an oven of said frozen, pre-baked, dough piece lasting 5 minutes or less at an oven temperature of between 200° C. and 260° C., preferably of 3 minutes or less at between 200° C. and 260° C., it being recalled that the final baking is advantageously conducted at an oven temperature of 220° C. to 260° C., preferably between 230° C. and 250° C. This process comprises the following steps:
obtaining a formed, fermented, dough piece ready to be baked, corresponding to the baked product;
pre-baking said dough piece in the oven until:
   its crumb has coagulated, and
   a coloured crust is formed;
freezing the pre-baked dough piece thus obtained, the dough piece being a dough piece in any of the forms of embodiment described above.

The invention also concerns the corresponding frozen, pre-baked, dough piece.

As indicated above, the frozen, pre-baked, dough piece allows to obtain a baked product through a mere final baking of 5 minutes or less, at an oven temperature of between 200° C. and 260° C.

It was ascertained, however, that in some particular applications the pre-baked dough piece is acceptable for the consumer even at the partly baked stage i.e. with no final baking. It appears that after thawing the pre-baked dough piece can be used, without any final baking, for the preparation of filled sandwiches of acceptable quality. The pre-baked dough pieces in the form of bread rolls, half-baguettes or short baguettes are particularly suitable for said use. It is recalled that a frozen, pre-baked, dough piece distinguishes itself from a fully baked, frozen dough piece in that the frozen pre-baked dough piece, after final baking corresponding to 2 to 3 minutes in an oven at a temperature of between 200° C. and 260° C., gives a fresh baked product with no unpleasant crust flaking.

The invention also concerns bread improvers to implement the making processes of the invention (processes for producing a baked product, and processes for producing a frozen pre-baked dough piece), and the use of said improvers in said bread-making processes.

The invention particularly concerns a bread improver intended for the manufacturing processes according to the invention, containing in combination:
a stabilizer chosen from the group of cellulose derivatives, pre-gelatinized starches and pre-gelatinized cereal flour;
whey;
and dextrose.

The invention also concerns said improver containing in combination a pre-gelatinized bread-making cereal flour, preferably a pre-gelatinized wheat flour, and an amyloglucosidase, preferably also in combination with a hemicellulase giving C5 sugars and/or a maltogenic exoamylase. In further preferred manner, said improver, in addition to said enzymatic preparation(s) and with respect to 100 kg of flour used, is able to provide in Baker's Percentage: 1% to 4% pre-gelatinized bread-making cereal flour, preferably pre-gelatinized wheat flour, and only those additives authorised in ordinary French bread according to European directive 95/2CE and in particular 0.009% to 0.020% ascorbic acid, preferably 0.009% to 0.015% ascorbic acid.

In particular, the invention concerns a baking improver able to provide, per 100 kg of flour used and in Baker's Percentage:
1% to 3% dextrose (=glucose)
0.5% to 4% whey, and
0.3% to 1% carboxymethylcellulose and/or 1 to 4% pre-gelatinized bread-making cereal flour.

The improver may also contain malted cereals. Preferably, the improver contains malted wheat or malted barley, and further preferably malted wheat. According to one particularly useful aspect, the improver, per 100 kg of flour used and in Baker's Percentage also provides: 0.1% to 1% of malted cereals (such as defined above), preferably malted wheat or malted barley, and most preferably malted wheat.

Another aspect of the invention is the achievement of baked bread product using a process comprising the final baking of a frozen, pre-baked, dough piece by placing said frozen, pre-baked, dough piece in an oven for a time of 5 minutes or less at between 200° C. and 260° C., preferably for 3 minutes or less at between 200° C. and 260° C., further preferably for 2 to 3 minutes at 200° C. to 260° C., this final baking preferably being conducted at an oven temperature of 220° C. to 260° C., further preferably between 230° C. and 250° C.

As already indicated above, during this final baking, the frozen pre-baked dough piece may be placed directly in the oven or may be subjected to a partial or full thawing step before it is put in the oven for final baking. The invention also relates to the frozen, pre-baked, dough piece that is solely thawed.

The invention also concerns baked products obtained using the process according to the invention.

The invention is of interest for breads having a crust, such as (half-) baguettes and bread rolls.

The present invention is also useful for baked products chosen from among all types of breads, including special breads, pains viennois (sweetened breads) and milk rolls. The weight of the baked product may vary between 30 g and 2 kg. The invention is of particular interest for dough pieces weighing 200 g to 2 kg. It does not concern pizza dough, so-called yeast raised sweet pastries (“viennoiseries”) such as croissants and brioches.

With the present invention a quality fresh, baked product can now be provided in 5 minutes or less, even 3 minutes or less.

This is of particular advantage for sales at bakery outlets, but the invention also enables bakers to give satisfaction to customers urgently desiring a fresh bread product after the day's direct production has been sold out. Finally the invention is also of interest for consumers who wish to obtain baked products of quality, by conducting the final baking operation themselves.

The advantages of the present invention are illustrated more clearly in the examples below.

### EXAMPLES

### Examples 1 and 2

### Minute-Baked Bread of the Invention; and Comparative Example C: Bread from Frozen Pre-Baked Dough

1) Preparation of the Dough Ready to be Baked

The production formula for preparing the ready to be baked dough, used for examples 1 and 2 according to the invention and for comparative example C, close to industrial formula, is given in Table 1.

TABLE 1

| | |
|---|---|
| Mixing: | 2 minutes at 1^{st} speed on spiral kneading |
| | machine |
| Mixing: | 6 minutes at 2^{nd} speed on spiral kneading |
| | machine |
| Bulk | 5 minutes |
| fermentation: | |
| Dividing: | Weight of dough pieces: 350 g |
| Rounding: | mechanical |
| Relaxing: | 15 minutes |
| Moulding: | mechanical, into baguettes |
| Proofing: | 1 h 45 at room temperature of 27° C. |

2) Composition of the Dough

The formulas of doughs 1 and 2 according to the invention and of the dough according to comparative example C are expressed, as is usual in this technical area, in Baker's Percentage, i.e. in parts by weight of ingredient per 100 parts by weight of cereal flour used. They are given in table 2.

Fresh bread-making yeast or pressed bread-making yeast is a yeast with approximately 30% dry matter sold under the trade name “L'HIRONDELLE”® bleu by GIE LESAFFRE at 94701 Maisons Alfort, France.

The improver IBIS® bleu is an improver of conventional formulation for ordinary French bread marketed by GIE LESAFFRE in Maisons-Alfort, France and by LESAFFRE INTERNATIONAL, Division Ingrédients at 59700 Marcq-en-Baroeul, France. This improver, in particular, provides the necessary doses of ascorbic acid and enzymatic preparations to obtain quality bread following the procedure given above (see Table 1).

The improving compositions “G” and “N” of the invention used in examples 1 and 2 are described in Tables 3a and 3b.

TABLE 2

| | | Example 1 | Example 2 |
|---|---|---|---|
| | Comparative | of the | of the |
| 350 g baguette, dough | example C | invention | invention |
| Wheat flour type 55 | 100.0 | 100.0 | 100.0 |
| Water | 60.0 | 63.0 | 63.0 |
| Salt | 1.8 | 1.8 | 1.8 |
| Fresh yeast (with | 2.5 | 2.5 | 2.5 |
| approx. 30% dry | | | |
| matter) | | | |
| “L'HIRONDELLE” ® bleu | | | |
| Bread improver IBIS ® | 1.0 | / | / |
| bleu | | | |
| “G” improving | / | 4.0 | / |
| composition of the | | | |
| invention | | | |
| “N” improving | / | / | 6.0 |
| composition of the | | | |
| invention | | | |

TABLE 3a

| “G” improving | | Dose used |
|---|---|---|
| composition of the | Composition | (baker's |
| invention | (parts by weight) | percentage) |
| Dextrose | 50.86 | 2.0344 |
| Lactoserum | 25.00 | 1.0000 |
| Carboxymethylcellulose | 12.50 | 0.5000 |
| Malted wheat flour | 7.50 | 0.3000 |
| DATEM | 3.75 | 0.1500 |
| Ascorbic acid | 0.30 | 0.0120 |
| Fungal hemicellulases | 0.04 | 0.0016 |
| Fungal alpha-amylases | 0.05 | 0.0020 |
| TOTAL | 100.00 | 4.0000 |

TABLE 3b

| “N” improving | | Dose used |
|---|---|---|
| composition of the | Composition | (baker's |
| invention | (parts by weight) | percentage) |
| Dextrose | 33.34 | 2.0004 |
| Pre-gelatinized flour | 33.34 | 2.0004 |
| Lactoserum | 16.67 | 1.0002 |
| Wheat flour | 8.89 | 0.5334 |
| Malted maize flour | 5.00 | 0.3000 |
| DATEM | 2.50 | 0.1500 |
| Ascorbic acid | 0.20 | 0.0120 |
| Fungal hemicellulases | 0.03 | 0.0018 |
| Fungal alpha-amylases | 0.03 | 0.0018 |
| TOTAL | 100.00 | 6.0000 |

3) Pre-Baking of the Dough Pieces

Pre-baking of the dough pieces is conducted in a rack oven of “Angoulevant” type with steam, marketed by Angoulevant/Eurofour at 59144 Gommegnies, France (see Table 4).

TABLE 4

| | Comparative | Examples 1 and 2 |
|---|---|---|
| | example C | of the invention |
| Oven pre-heating | 240 | 240 |
| temperature for pre- | | |
| baking (° C.) | | |
| Set pre-baking oven | 160 | 240 |
| temperature (° C.) | | |
| Pre-baking time (minutes) | 11 | 14 |

For information: to prepare a “straight dough” process baguette of the same type with a dough weight of 350 g i.e. fully baked, a preheating temperature of 240° C. may be used, a set temperature of 200° C. and a baking time of 22 minutes.
4) Freezing

The pre-baked dough pieces according to examples 1 and 2 of the invention and the pre-baked dough piece according to comparative example C are frozen in a deep freezer at −30° C. for 30 minutes, then stored at −20° C.

5) Final Baking

The final baking of the frozen pre-baked dough pieces is conducted in rack oven of “Angoulevant” type with steam (see Table 5).

TABLE 5

| | Comparative | Examples 1 and 2 |
|---|---|---|
| | example C | of the invention |
| Oven pre-heating | 240 | 250 |
| temperature for final | | |
| baking (° C.) | | |
| Set, final baking oven | 240 | 250 |
| temperature (° C.) | | |
| Final baking time | 10 | 2 to 3 |
| (minutes) | | |

6) Humidity of the Periphery

Measurements were made of the humidity of the periphery of the pre-baked dough pieces before freezing, and of the final baked products obtained in examples 1 and 2 according to the invention and in comparative example C (see Table 6).

TABLE 6

| | Comparative | Examples 1 and 2 |
|---|---|---|
| | example C | of the invention |
| Humidity of the periphery of | 36 | 32 |
| pre-baked dough pieces after | | |
| 30 min. cooling (wt. %) | | |
| Humidity of the periphery of | 31 | 31 |
| the final baked product after | | |
| 30 min. cooling (wt. %) | | |

Cooling relates to that part of cooling during which there is slight water evaporation.

The humidity of the periphery of the pre-baked dough pieces and of the baked product corresponds to the humidity of the surface area of the pre-baked dough piece or baked product, which is approximately 1 cm thick; this surface area comprises the crust or the practically colourless, soft film for those pre-baked dough pieces in comparative example C.

7) Colouring

A measurement was made of the colour of the surface of the pre-baked dough pieces and of the final baked products obtained in examples 1 and 2 of the invention and in comparative example C (see Table 7). These measurements were conducted using a MINOLTA chromameter. The MINOLTA chromameter is configured in the L*a*b* representation, which is one of the recommended uniform calorimetric spaces for more accurate relation to human vision of colours and the perceived interpretation of different colours.

In this configuration:
“L” indicates the lightness factor (the higher the value of “L”, the more the sample tends towards white).
“a” represents the green-red axis: this value varies between −60<“a”<+60. The low value characterizes the green and the high value characterizes the red.

“b” represents the yellow-blue axis. The scale is identical to that for “a”. It varies from −60<“b”<+60. The low value characterizes the blue and the high value characterizes the yellow.

TABLE 7

| | |
|---|---|
| Comparative | Examples 1 and 2 |
| example C | of the invention |

Top of crust

| | | | |
|---|---|---|---|
| After pre- | L | 70.85 | 45.62 |
| baking | a | −0.43 | 15.92 |
| | b | 18.55 | 27.12 |
| After final | L | 60.25 | 36.87 |
| baking | a | 9.78 | 15.40 |
| | b | 32.08 | 17.36 |

It can be seen that, in the products according to the invention, the crust is much darker than in the pre-baked dough process according to comparative example C, whether after pre-baking or after final baking. The product according to inventive examples 1 and 2 after pre-baking is even slightly darker than the product baked according to comparative example C after final baking.

It can also be seen that the products according to the invention have a greater red colour crust intensity and a lesser yellow intensity.

8) Results

In the process according to the invention, the shrinkage of the dough piece during final baking is less than 5% of the volume of the baked product. This is a major advantage compared with the traditional frozen pre-baked process, in which a shrinkage of at least 10% is observed during final baking, i.e. at least twice as much.

The crumb of the products baked according to the invention does not have any rings or white patches as in the case of a fully baked product which has been frozen and then thawed.

The colour of the crust of the products baked according to the invention has the typical, appreciated or known colour of a baked product obtained with a straight dough process i.e. with no pre-baking or freezing step.

Experience has shown that the known process with frozen, pre-baked dough often leads to flaking of the crust. No unpleasant flaking of the crust occurs when using the process according to the invention.

It has also been observed that, contrary to the known process with frozen pre-baked dough, of which comparative example C is an illustration, the process according to the invention is not limited to baked products of small size, but can also be used to produce quality baked products of greater size, e.g. 1 to 2 kg.

At the end of the final baking, the baked product of the invention releases the aroma of a freshly baked product.

As illustrated in the examples, with the present invention it is possible to provide customers at any time of the day, and after a final baking time of only a few minutes, with an oven-fresh product of quality!

1-28. (canceled)

29. A process for preparing a frozen, pre-baked dough piece able to yield a baked bread product by final baking, corresponding to the placing of said frozen, pre-baked dough piece in an oven at an oven temperature of between 200° C. and 260° C. for a time of 5 minutes or less, said process comprising the following steps:
obtaining a moulded, fermented dough piece ready to bake, corresponding to said baked product;
pre-baking said dough piece in an oven until:
its crumb has coagulated and
a coloured crust has formed;
freezing the pre-baked, dough piece obtained.

30. The process according to claim 29, wherein pre-baking is conducted at an oven temperature of 220° C. to 260° C.

31. The process according to claim 29, wherein a baked product is obtained whose crust does not flake, and whose volume is at least equal to 95% of the volume which would be obtained if the moulded, fermented dough piece ready to bake had been directly baked in a single baking step with no freezing step.

32. The process according to claim 29, wherein the dough piece is prepared with ingredients which, in addition to cereal flour, yeast and water, contain a sugar taking part in Maillard-type reactions in a quantity exceeding the quantity fermented by the yeast before pre-baking and sufficient to impart colour to the crust during pre-baking, and/or proteins taking part in Maillard-type mechanisms.

33. The process according to claim 32, wherein the ingredients of the dough piece contain at least one ingredient containing a sugar or a protein taking part in Maillard-type reactions, this ingredient being selected from the group consisting of the family of whey powder, lactose, glucose, galactose, sucrose, fructose, sorbitol.

34. The process according to claim 32, wherein the excess sugar taking part in Maillard-type reactions is at least partly contributed during fermentation of the dough piece by at least one enzymatic preparation.

35. The process according to claim 34, wherein the ingredients of the dough piece contain at least one enzyme selected from the group consisting of the family of hemicellulases releasing sugars with 5 carbons atoms and exoamylases.

36. The process according to claim 29, wherein the dough piece is prepared with ingredients which, in addition to cereal flour, yeast and water, contain food fibres and/or a food stabilizer.

37. The process according to claim 36, wherein said food stabilizer is selected from the group consisting of carboxymethylcellulose, xanthan gum, pre-gelatinized wheat flour and pre-gelatinized maize flour.

38. The process according to claim 36, wherein the ingredients of the dough piece contain pre-gelatinized starch, or a source of pre-gelatinized starch.

39. The process according to claim 29, wherein the dough piece is prepared with cereal flour, yeast, water and ingredients containing both:
an ingredient containing a sugar or proteins taking part in Maillard-type reactions;
a food stabilizer.

40. The process according to claim 39, wherein the dough piece is prepared with ingredients containing all the following:
a source of enzymes which, during fermentation of the dough, contributes sugars taking part in Maillard-type reactions;
a food stabilizer.

41. The process according to claim 39, wherein the dough piece is prepared with ingredients containing malted cereals.

42. The process according to claim 39, wherein the dough piece contains at least one the three following bread-making adjuvants:
an oxidising agent;
an emulsifier,
an enzymatic preparation selected from the group consisting of non-maltogenic alpha-amylases, endo-alpha-amylases, hemicellulases, lipases, phospholipases, or a combination of these enzymatic preparations.

43. The process according to claim 39, wherein the dough piece before pre-baking has a hydration of at least 62%.

44. The process according to claim 29, wherein the dough piece is prepared with ingredients containing a combination of:
a stabilizer selected from the group consisting of cellulose derivatives, pre-gelatinized starches and pre-gelatinized cereal flours;
whey powder; and
dextrose.

45. The process according to claim 29, wherein the dough piece is prepared with ingredients containing a combination of:
a pre-gelatinized bread-making cereal flour,
an amyloglucosidase.

46. The process according to claim 45, wherein the dough piece is prepared with ingredients containing, in baker's percentage, a combination of:
1% to 3% dextrose;
0.5% to 4% whey powder, and
0.3% to 1% carboxymethylcellulose and/or 1% to 4% pre-gelatinized bread-making cereal flour.

47. The process according to claim 46, wherein the dough piece, in addition to the enzymatic preparation(s), is prepared with ingredients containing in baker's percentage a combination of:
1% to 4% pre-gelatinized bread-making cereal flour, and
only additives allowed in ordinary French bread (“pain courant français”) according to European directive 95/2 CE.

48. The process according to claim 44, wherein the ingredients of the dough piece contain malted cereals.

49. The process according to claim 48, wherein the dough piece is prepared with ingredients which, in baker's percentage, contain 0.1% to 1% malted cereals.

50. A frozen, pre-baked dough piece obtained by the process according to claim 29.

51. A process for obtaining a baked bread product comprising the final baking of a frozen, pre-baked dough piece according to claim 50 by placing said frozen, pre-baked dough piece in an oven for a time of 5 minutes or less at between 200° C. and 260° C.

52. The process according to claim 51, wherein the final baking is conducted at a temperature of 220° C. to 260° C.

53. The process according to claim 51, wherein the baked product is selected from the group consisting of breads with crusts, “pains viennois” (sweetened breads), and milk rolls.
